(19) United States
(12) Patent Application Publication
(10) Pub. No.: US 2019/0001347 A1
(43) Pub. Date: Jan. 3, 2019

(54) FILTRATION DEVICES FOR BIOLOGICAL SAMPLES

(71) Applicant: BOSTON SCIENTIFIC SCIMED, INC., Maple Grove, MN (US)

(72) Inventors: SHANNON SMITH KENWOOD, Hopkinton, MA (US); SARAH JEAN HEIGHTON, Clinton, MA (US); JOSHUA CLARK, Spencer, IN (US); DAN BACON, Fitchburgh, MA (US)

(73) Assignee: BOSTON SCIENTIFIC SCIMED, INC., Maple Grove, MN (US)

(21) Appl. No.: 16/018,897

(22) Filed: Jun. 26, 2018

Related U.S. Application Data
(60) Provisional application No. 62/527,357, filed on Jun. 30, 2017.

(51) Int. Cl. B04B 5/04; B01D 21/26; B01D 61/14; B01D 61/18

(52) U.S. Cl. CPC B04B 5/0442; B01D 21/262; B01D 61/147; B04B 2005/0478; B01D 2221/10; B01D 2311/2676; B01L 2300/0681; B01D 61/18

(57) ABSTRACT

Filtration devices and methods for collecting, filtering, and/or processing biological samples are disclosed. An example filtration device may include a funnel member having a first end region and a second end region. A flange may be coupled to the first end region. A filter support portion may be coupled to the second end region. The filter support portion may include a base, a filter membrane coupled to the base, and a securing member for securing the filter membrane to the base.

### CROSS-REFERENCE TO RELATED APPLICATIONS

This application claims priority under 35 U.S.C. § 119 to U.S. Provisional Application Ser. No. 62/527,357, filed Jun. 30, 3017, the entirety of which is incorporated herein by reference.

### TECHNICAL FIELD

The present disclosure pertains to medical devices, and methods for manufacturing medical devices. More particularly, the present disclosure pertains to filtration devices for biological samples.

### BACKGROUND

A wide variety of medical devices have been developed for medical use, for example for collecting and/or processing biological samples. Some of these devices include filtration devices.

### BRIEF SUMMARY

This disclosure provides design, material, manufacturing method, and use alternatives for medical devices. An example medical device includes a filtration device. The filtration device comprises a funnel member having a first end region and a second end region; a flange coupled to the first end region; a filter support portion coupled to the second end region; and wherein the filter support portion includes a base, a filter membrane coupled to the base, and a securing member for securing the filter membrane to the base.

Alternatively or additionally to any of the embodiments above, the flange is designed to support the funnel member within a centrifuge tube.

Alternatively or additionally to any of the embodiments above, the securing member includes an outer ring designed to be disposed along an outer surface of the base to secure the filter membrane to the base.

Alternatively or additionally to any of the embodiments above, the base includes an outer retaining region for retaining the outer ring.

Alternatively or additionally to any of the embodiments above, the securing member includes an inner ring designed to be disposed along an inner surface of the base to secure the filter membrane to the base.

Alternatively or additionally to any of the embodiments above, the base includes an inner retaining region for retaining the inner ring.

Alternatively or additionally to any of the embodiments above, the filter support portion is designed to be releasably attached to the funnel member.

Alternatively or additionally to any of the embodiments above, the filter membrane includes a plurality of pores having a diameter of 5 microns or less.

A method for processing a biological sample is disclosed. The method comprises: collecting the biological sample using an aspiration device; transferring the biological sample from the aspiration device to a centrifugation and filtration assembly; wherein the centrifugation and filtration assembly include a centrifuge tube and a filtration device disposed within the centrifuge tube; wherein the filtration device comprises: a funnel member having a first end region and a second end region, a flange coupled to the first end region, a filter support portion coupled to the second end region, and wherein the filter support portion includes a base, a filter membrane coupled to the base, and a securing member for securing the filter membrane to the base; and centrifuging the centrifugation and filtration assembly for processing the biological sample.

A method for processing a biological sample is disclosed. The method comprises: collecting a biological sample using a fine needle aspiration device; transferring the biological sample from the fine needle aspiration device to a centrifugation and filtration assembly; wherein the centrifugation and filtration assembly include a centrifuge tube and a filtration device disposed within the centrifuge tube; wherein the filtration device comprises: a funnel member having a first end region and a second end region, a flange coupled to the first end region, a filter support portion coupled to the second end region, and wherein the filter support portion includes a base, a filter membrane coupled to the base, and a securing member for securing the filter membrane to the base; and centrifuging the centrifugation and filtration assembly.

Alternatively or additionally to any of the embodiments above, further comprising removing the filtration device from the centrifuge tube.

Alternatively or additionally to any of the embodiments above, further comprising disposing the filtration device within a secondary tube.

Alternatively or additionally to any of the embodiments above, the filter support portion is detachable from the funnel member, and further comprising detaching the filter support portion from the funnel member.

Alternatively or additionally to any of the embodiments above, further comprising adding a washing solution to the filtration device.

Alternatively or additionally to any of the embodiments above, the centrifuge tube further comprises a cap designed to secured to the centrifuge tube, and further comprising securing the cap to the centrifuge tube.

Alternatively or additionally to any of the embodiments above, centrifuging the centrifugation and filtration assembly includes centrifuging the centrifugation and filtration assembly at a speed sufficient to generate a relative centrifugal force of 800-1200 times gravitational acceleration.

An assembly for processing a biological sample collected using a fine needle aspiration device is disclosed. The assembly comprises: a centrifugation tube; a cap designed to be secured to the centrifugation tube; a filtration frame disposed within the centrifugation tube, the filtration frame comprising a flange portion designed to engage the centrifugation tube while allowing the cap to be secured to the centrifugation tube, a funnel portion, and a filter member releasably coupled to the funnel portion; and wherein the filter member includes a base, a filter membrane coupled to the base, and a securing member for securing the filter membrane to the base.

Alternatively or additionally to any of the embodiments above, the securing member includes an outer ring designed to be disposed along an outer surface of the base to secure the filter membrane to the base.

Alternatively or additionally to any of the embodiments above, the base includes an outer retaining region for retaining the outer ring.

Alternatively or additionally to any of the embodiments above, the securing member includes an inner ring designed to be disposed along an inner surface of the base to secure the filter membrane to the base.

Alternatively or additionally to any of the embodiments above, the base includes an inner retaining region for retaining the inner ring.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 schematically illustrates an example centrifugation and filtration assembly.

FIG. 2 is a side view of an example filtration device.

FIG. 3 illustrates an example centrifugation and filtration assembly with a cap.

FIG. 4 is an exploded view of an example filter support member.

FIG. 5 illustrates an example filter support member.

FIG. 6 illustrates an example filter support member.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

There are a number of methods for the collection of biological samples by a biopsy and/or other surgical processes. Such processes typically result in a tissue sample that can be routinely processed for pathological analysis. In some endoscopic procedures such as those where a fine needle aspiration device is utilized, the sample that is collected includes loose cells and fluids. Prior to tissue processing and/or analysis, additional steps may be necessary to gather the desired cells/tissue and allow the cells/tissue to be further processed. Disclosed herein are devices and methods that allow cells/tissue to be efficiently processes and/or analyzed including cells/tissue gathered by fine needle aspiration devices and/or other devices that collect cells/tissue along with fluids.

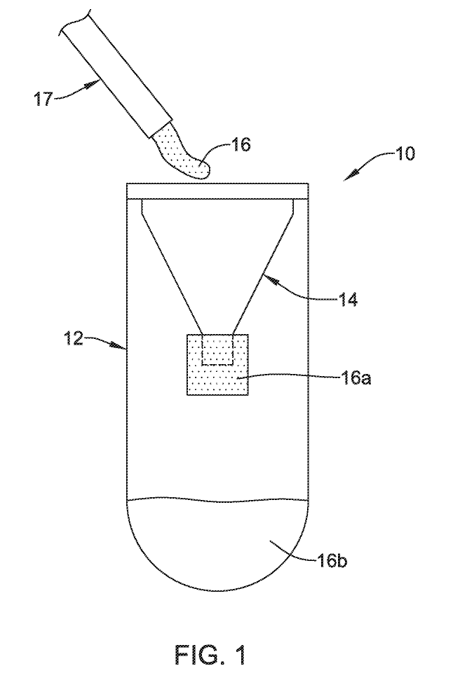

FIG. 1 schematically illustrates an example centrifugation and filtration assembly 10. The assembly 10 includes a tube such as a centrifuge tube 12 and a filtration device 14. While the word “centrifuge” is used in describing the tube 12, this is not intended to be limiting. A variety of tubes, including tubes that may or may not include structural features that allow the tube to be adapted for use with a centrifuge, are contemplated for the tube 12. The tube 12 may vary in size, capacity, shape, type, etc. For example, the tube 12 may take the form of a 15-50 ml tube (e.g., such as a 15 ml or a 50 ml conical tube). In other instances, the tube 12 may be a smaller tube such as a 0.1-5 ml “tube (e.g., an EPPENDORF™ tube). The tube 12 may or may not include a cap. The cap may be a structural component that is part of (e.g., attached to the tube 12 with an arm or tether) the tube 12. Alternatively, the cap may be a separate structure that can be secured to the tube 12. Numerous other tubes are contemplated having a number of different features.

A biological sample 16 may be collected and added to the assembly 10. In at least some instances, the biological sample 16 may be collected by a fine needle aspiration device 17. Alternatively, the biological sample 16 may be collected by a surgical and/or biopsy device. In other instances, the biological sample may include a cultured sample or otherwise be derived from a cell culture, a laboratory sample, or the like. The sample 16, for example, may be transferred from the fine needle aspiration device 17 to the filtration device 14. When doing so, the sample 16 may be separated or “filtered” into a first component 16a and a second component 16b. In this example, the biological sample 16 may contain cells/tissue in a fluid. Accordingly, when the sample 16 is transferred to the filtration device 14, the filtration device 14 may begin to separate the cells/tissue (e.g., which may correspond to the first component 16a) from the fluid (e.g., which may correspond to the second component 16b).

In at least some instances, the filtration device 14 is designed to be seated within the tube 12 in a manner that allows the assembly 10 to be centrifuged when the sample 16 is added to the filtration device. Centrifugation may allow the sample 16 to further separate (e.g., such that the first component 16a may be more fully separated from the second component 16b). In addition, the filtration device 14 may also be designed so that the filtration device 14 can be removed from the tube 12. When doing so, the filtration device 14 can be replaced in the same tube 12 (e.g., following the removal of the second component 16b of the sample 16) and/or the filtration device 14 may be disposed within another tube (e.g., a secondary tube that may be same or different from the tube 12). In some instances, the filtration device 14, or more particularly the first component 16a of the sample 16 captured on the filtration device 14, may be subjected to further processing. Such further processing may include rinsing, washing, fixing, and/or the like. For example, the first component 16a may be washed and/or fixed with saline, formalin, and/or the like. If desired, the filtration device 14 can be moved one or more times to additional tubes and/or subjected to further rinsing, washing, fixing, and/or the like, as desired.

When the sample 16 is suitably prepared, the sample 16 (or, more particularly, the first component 16a of the sample 16) can be processed using the desired techniques. This may include fixing the cells (e.g., chemically fixing using a suitable material such as formalin), freezing the cells, dehydrating the cells using a suitable material such as ethanol, clearing or otherwise processing the cells with xylene or another suitable agent, embedding the cells in a suitable material (e.g., in paraffin or the like), transferring the cells to a histology cassette, combinations thereof, or the like.

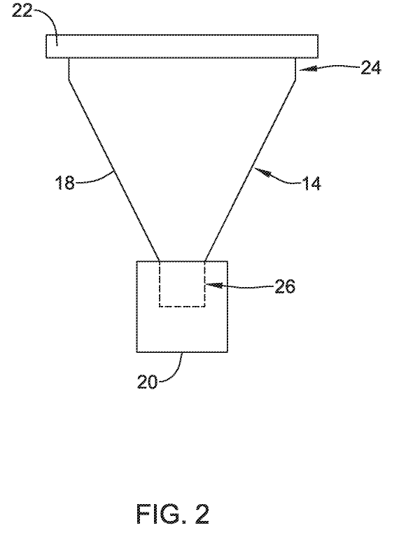

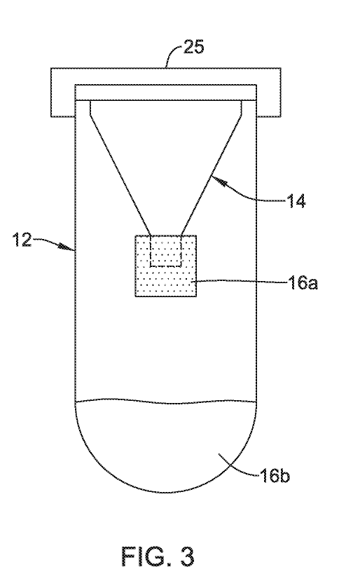

FIG. 2 illustrates the filtration device 14. Here it can be seen that the filtration device 14 may include a funnel member or portion 18 and a filter support member or portion 20. The filtration device 14 may be formed from a suitable metal and/or polymeric material. In some instances, a lip or flange 22 may be coupled to or otherwise disposed at a first end region 24 of the funnel portion 18. The flange 22 may be designed so that the filtration device 14 can be disposed in the tube 12 in a manner that allows a cap 25 to be disposed on the tube 12 as shown in FIG. 3. This may include seating the flange 22 just inside the tube 12, seating the flange 22 on a ledge or ridge formed along the tube 12, resting the flange 22 on the end surface of the tube 12, etc. In some instances, the first end region 24 may lack the flange 22. The funnel portion 18 may be designed to help transfer or otherwise “funnel” a biological sample (e.g., the biological sample 16) toward the filter support portion 20.

The filter support portion 20 may be designed to be coupled to a second end region 26 of the funnel portion 18. In some instances, the filter support portion 20 may attach to the funnel portion 18 by a friction fit, an interference fit, a threaded connection, or other suitable bond. In at least some instances, the filter support portion 20 is releasably attached to the funnel portion 18. A releasable bond may allow the filter support portion 20 to be removed from the funnel portion 18 so that cells/tissue collected thereon can be further processed in an efficient manner.

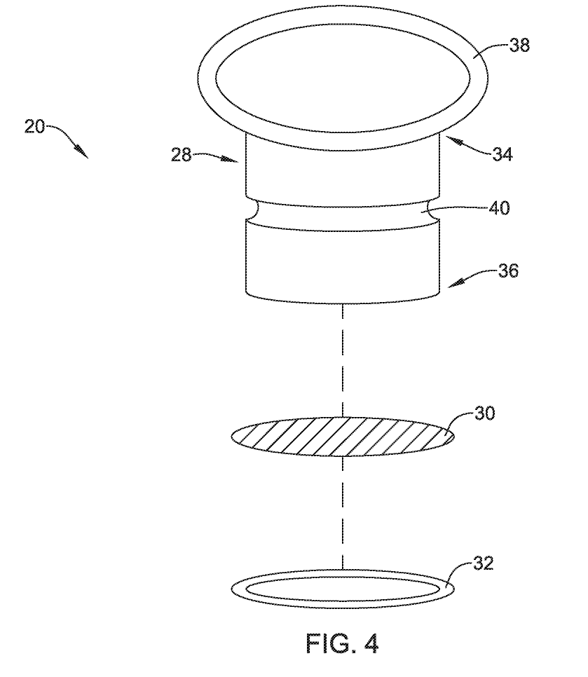

FIG. 4 is an exploded view illustrating the components of the filter support portion 20. Here it can be seen that the filter support portion 20 may include a substrate or base 28, a filter membrane 30, and a ring or securing member 32 for securing the filter membrane 30 to the base 28. The base 28 may include a first or top end 34 and a second or bottom end 36. The top end 34, the bottom end 36, or both may be open. In other words, the base 28 may have a shape that resembles a cylinder with open ends. Alternatively, the bottom end 36 may be fully or partially closed. The top end 34 may include a flange 38. The flange 38 may aid in removing the filter support portion 20 from the funnel portion 18. The filter membrane 30 may include a porous material with openings sized to allow the desired cells/tissue to be collected thereon while allowing fluids to pass therethrough. For example, the filter membrane 30 have pores that are about 0.1-50 microns, or about 1-20 microns, or about 2-10 microns, or about 5 microns, or smaller than about 10 microns, or smaller than about 5 microns, or the like.

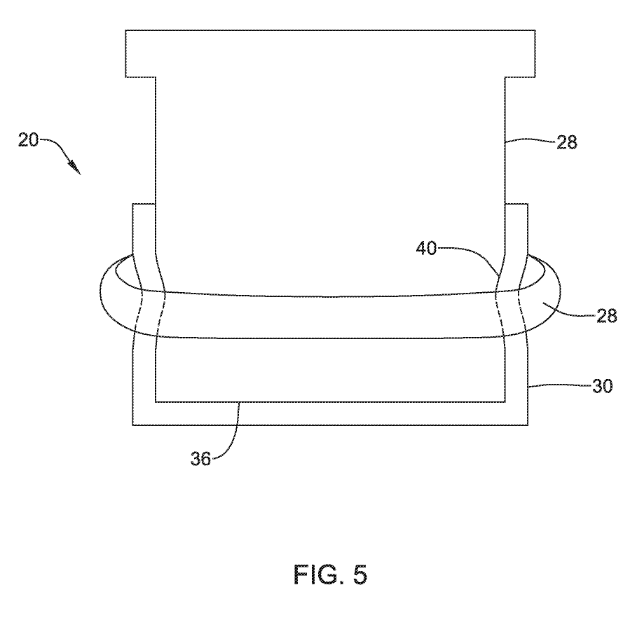

In at least some instances, the securing member 32 is designed so that the filter membrane 30 can be securely attached to the base 28 that allows for the filtration device 14 (and/or the assembly 10) to be centrifuged. For example, the base 28 may include a retaining region 40. The retaining region 40 may take the form of a groove, socket, or the like disposed along an outer surface of the base 28. The securing member 32, which may take the form of a resilient or rigid ring of material, may be passed over the bottom end 36 of the base 28 and be seated in the retaining region 40 in order to more securely attach the filter membrane 30 to the base 28. For example, the filter membrane 30 may be disposed along the bottom end 36 of the base 28 as shown in FIG. 5. The securing member 32 may be disposed about a portion of the filter membrane 30 to secure the filter membrane 30 to the base 28. This may include securing the securing member 32 with the retaining region 40. With the filter membrane 30 secured to the base 28 with the securing member 32, the filtration device 14 (and/or the assembly 10) can be centrifuged at speeds sufficient to generate a relative centrifugal force of 200-1800 times gravitational acceleration (e.g., 200-1800 RCF).

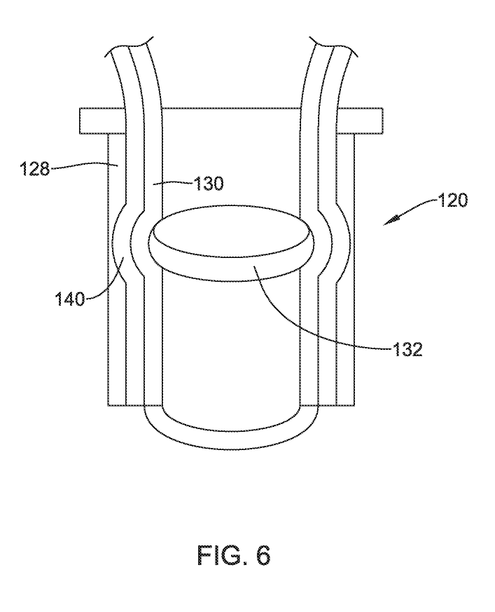

While disposing the securing member 32 along the outer surface of the base 28 may be sufficient to secure the filter membrane 30 to the base 28, other arrangements are contemplated. For example, FIG. 6 illustrates another example filter support portion 120 that may be similar in form and function to other filter support portions disclosed herein. The filter support portion 120 may include a base 128, a filter membrane 130, and a securing member 132 for securing the filter membrane 130 to the base. In this example, the base 128 may include a retaining region 140 disposed along an inner surface of the base 128. The securing member 132 may be seated in the retaining region 140 in order to more securely attach the filter membrane 130 to the base 128.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A filtration device, comprising:
a funnel member having a first end region and a second end region;
a flange coupled to the first end region;
a filter support portion coupled to the second end region; and
wherein the filter support portion includes a base, a filter membrane coupled to the base, and a securing member for securing the filter membrane to the base.

2. The filtration device of claim 1, wherein the flange is designed to support the funnel member within a centrifuge tube.

3. The filtration device of claim 1, wherein the securing member includes an outer ring designed to be disposed along an outer surface of the base to secure the filter membrane to the base.

4. The filtration device of claim 3, wherein the base includes an outer retaining region for retaining the outer ring.

5. The filtration device of claim 1, wherein the securing member includes an inner ring designed to be disposed along an inner surface of the base to secure the filter membrane to the base.

6. The filtration device of claim 5, wherein the base includes an inner retaining region for retaining the inner ring.

7. The filtration device of claim 1, wherein the filter support portion is designed to be releasably attached to the funnel member.

8. The filtration device of claim 1, wherein the filter membrane includes a plurality of pores having a diameter of 5 microns or less.

9. A method for processing a biological sample, the method comprising:
collecting the biological sample using an aspiration device;
transferring the biological sample from the aspiration device to a centrifugation and filtration assembly;
wherein the centrifugation and filtration assembly include a centrifuge tube and a filtration device disposed within the centrifuge tube;
wherein the filtration device comprises:
a funnel member having a first end region and a second end region,
a flange coupled to the first end region,
a filter support portion coupled to the second end region, and
wherein the filter support portion includes a base, a filter membrane coupled to the base, and a securing member for securing the filter membrane to the base; and
centrifuging the centrifugation and filtration assembly for processing the biological sample.

10. The method of claim 9, further comprising removing the filtration device from the centrifuge tube.

11. The method of claim 10, further comprising disposing the filtration device within a secondary tube.

12. The method of claim 9, wherein the filter support portion is detachable from the funnel member, and further comprising detaching the filter support portion from the funnel member.

13. The method of claim 9, further comprising adding a washing solution to the filtration device.

14. The method of claim 9, wherein the centrifuge tube further comprises a cap designed to secured to the centrifuge tube, and further comprising securing the cap to the centrifuge tube.

15. The method of claim 9, wherein centrifuging the centrifugation and filtration assembly includes centrifuging the centrifugation and filtration assembly at a speed sufficient to generate a relative centrifugal force of 800-1200 times gravitational acceleration.

16. An assembly for processing a biological sample collected using a fine needle aspiration device, the assembly comprising:
a centrifugation tube;
a cap designed to be secured to the centrifugation tube;
a filtration frame disposed within the centrifugation tube, the filtration frame comprising a flange portion designed to engage the centrifugation tube while allowing the cap to be secured to the centrifugation tube, a funnel portion, and a filter member releasably coupled to the funnel portion; and
wherein the filter member includes a base, a filter membrane coupled to the base, and a securing member for securing the filter membrane to the base.

17. The assembly of claim 16, wherein the securing member includes an outer ring designed to be disposed along an outer surface of the base to secure the filter membrane to the base.

18. The assembly of claim 17, wherein the base includes an outer retaining region for retaining the outer ring.

19. The assembly of claim 16, wherein the securing member includes an inner ring designed to be disposed along an inner surface of the base to secure the filter membrane to the base.

20. The assembly of claim 19, wherein the base includes an inner retaining region for retaining the inner ring.
